(19) United States
(12) Patent Application Publication
(10) Pub. No.: US 2025/0173596 A1
(43) Pub. Date: May 29, 2025

(54) OPTIMISATION TECHNIQUES FOR VARIATIONAL QUANTUM ALGORITHMS USING NOISY QUANTUM PROCESSING HARDWARE

(71) Applicant: HSBC Group Management Services Limited, London (GB)

(72) Inventors: Georgios KORPAS, Singapore (SG); Jakub MARECEK, Pague (CZ); Philip INTALLURA, London (GB); Daniel MASTROPIETRO, Zurich (CH); Vyacheslav KUNGURTSEV, Pague (CZ)

(21) Appl. No.: 18/963,276

(22) Filed: Nov. 27, 2024

(30) Foreign Application Priority Data
Nov. 28, 2023 (GB) 2318165.4

(51) Int. Cl. G06N 10/60

(52) U.S. Cl. CPC G06N 10/60

(57) ABSTRACT

A method of executing a variational quantum algorithm, VQA, using a hybrid computer system comprising a quantum computer and a classical computer is disclosed. An optimisation process is performed to optimize a cost function with respect to a set of circuit parameters of a parameterized quantum circuit. A value of the cost function is dependent on an output of the parameterized quantum circuit when run on the quantum computer. The optimisation process comprises a plurality of parallel searches through the search space of possible sets of values of the circuit parameters. The optimisation process is performed iteratively and includes, at each iteration, updating a current set of parameter values for each of the plurality of parallel searches based on the cost function in accordance with an optimisation procedure, the current set of parameter values of a search corresponding to a location of the search in the search space. At a given iteration of the optimisation process, a given one of the parallel searches that has stalled is identified based on gradient information of the cost function at a current location of the search in the search space meeting a stall criterion. A new set of parameter values is then assigned to the stalled search corresponding to a location in the search space different from the current location of the stalled search, and the stalled search is continued in subsequent iterations from the different location based on the assigned parameter values. Upon termination of the parallel searches, a set of circuit parameter values corresponding to an optimal cost function value found by the parallel searches is identified and provided as output.

### CROSS-REFERENCE WITH RELATED APPLICATIONS

This application claims priority to United Kingdom Application No. 2318165.4, filed Nov. 28, 2023, the contents of which is incorporated into the present application by reference.

### FIELD OF THE INVENTION

The present invention relates to quantum computing, specifically to improved optimization techniques for variational quantum algorithms (VQAs) that are more robust to the detrimental effects of noise inherent in Noisy Intermediate-Scale Quantum (NISQ) computers.

### BACKGROUND OF THE INVENTION

In recent years, the study of quantum algorithms has experienced a surge of interest, particularly concerning the development of efficient approaches for addressing NP-Hard optimization problems. Among these advancements, Variational Quantum Algorithms (VQAs) have emerged as an important category of quantum algorithms, encapsulating key techniques such as the Variational Quantum Eigensolver (VQE) and the Quantum Approximate Optimization Algorithm (QAOA).

VQAs themselves find wide applicability across a range of technical fields, for example for solving optimisation problems in the space of chemistry and material science. In general, any form of mixed integer linear program found in any technical field can be mapped to some form of VQA. VQAs are heuristic methods and are typically considered for optimization problem instances where the resource requirements are too heavy for optimizers implemented on classical (i.e. non-quantum) computers.

Variational quantum algorithms work by running a parameterized quantum circuit that encodes the problem of interest, measuring the expected value of some observable relevant to this problem, classically learning the parameters that minimize a cost function related to the expected value of the observable and repeating until the process converges to some satisfactory value.

One major drawback of variational quantum algorithms is that they suffer from the so-called barren plateau problem, especially when the problem is approached with hardware efficient ansätze (that is, initial solution guesses ϑ of the problem). Barren plateaus are large regions in the parameter space, where the gradients of the cost function vanish, or are noisy around zero, which, in turn, makes efficient optimization very difficult. Concretely, most gradient descent algorithms work as

$${ϑ}_{ℓ} ( t + 1 ) - {ϑ}_{ℓ} ( t ) = - η \frac{\partial C}{\partial {ϑ}_{ℓ}} ,$$

where t is the time step of gradient descent dynamics, η is the learning rate, and C is the cost function. It has been observed that, if the chosen variational circuit is highly random, the gradient of the cost function is generally suppressed by the dimension of the Hilbert space and the variation of the cost function during gradient descent is very small, that is,

$$δ C ≡ \frac{C ( t + 1 ) - C ( t )}{C ( t )} ≪ 1 for step t .$$

This problem is in part due to the noisy nature of the NISQ quantum hardware that is typically available today, which can make optimization particularly challenging.

In more detail, the problem of barren plateaus may be considered to be related to the choice of cost function, circuit entanglement, circuit parameterization expressivity, and/or the presence of Pauli noise while it has been suggested that gradient-free methods such as the finite difference stochastic approximation algorithm (FDSA) and the simultaneous perturbation stochastic approximation algorithm (SPSA) may also suffer from the problem of barren plateaus. It is noteworthy that within quantum machine learning applications, similar to deep learning, one wants to achieve a high level of expressivity. Highly expressive parameterized circuits give rise to both standard as well as noise-induced barren plateaus.

### SUMMARY OF THE INVENTION

Aspects of the invention are set out in the independent claims. Certain preferred features are set out in the dependent claims.

Disclosed herein is a method of executing a variational quantum algorithm, VQA, using a hybrid computer system comprising a quantum computer and a classical computer, the method comprising:
receiving information defining a quantum circuit, wherein the quantum circuit is parameterized by a set of circuit parameters;
performing, using the classical computer, an optimisation process to optimise a cost function with respect to the circuit parameters, wherein a value of the cost function is based on an output of the parameterized quantum circuit when run on the quantum computer;
wherein the optimisation process comprises a plurality of parallel searches through the search space of possible sets of values of the circuit parameters;
wherein the optimisation process is performed iteratively and includes, at each iteration, updating a current set of parameter values for each of the plurality of parallel searches based on the cost function in accordance with an optimisation procedure, the current set of parameter values of a search corresponding to a location of the search in the search space, and wherein the optimisation process further comprises, at a given iteration:
   evaluating the cost function for each of the parallel searches based on execution of the parameterized quantum circuit on the quantum computer to obtain a cost value and gradient information corresponding to a current location of the search in the search space;
   identifying a given one of the parallel searches that has stalled based on the gradient information at the current location of the search meeting a stall criterion; and
   assigning to the stalled search a new set of parameter values corresponding to a location in the search space different from the current location of the stalled search, wherein the stalled search is continued in subsequent iterations from the different location based on the assigned parameter values;
the method further comprising, upon termination of the parallel searches, determining a set of circuit parameter values corresponding to an optimal cost function value found by the parallel searches; and
outputting the determined set of circuit parameter values.

References to parallel searches do not necessarily imply that processing for different searches occurs simultaneously, e.g. using separate/parallelized hardware processing devices (although that is a possible implementation), but merely indicates that the searches are not carried out sequentially (one after the other). Thus, the method may alternate between performing search steps for different ones of the searches rather than completing all search steps for one search before progressing to the next search.

The stall criterion preferably comprises the gradient vanishing at the search space location of the given search (e.g. the magnitude or components of the gradient vector falling below a threshold distance from zero, or being zero). Preferably, the stall criterion is based on the norm or magnitude of the gradient vector at the search location of the given search, the method preferably comprising determining whether the stall criterion is met based on comparing a measure determined from the norm or magnitude of the gradient vector at the search location to a threshold. The measure may be based on an average norm or magnitude of the gradient vector at the location of the given search over a number of search iterations, preferably a predetermined window of search iterations ending at the current iteration. The stall criterion may comprise the search having reached a barren plateau in the cost function landscape.

Assigning to the stalled search a new set of parameter values preferably comprises: selecting another one of the searches that has not stalled (according to the stall criterion); and assigning to the stalled search a set of parameter values based on the selected other search. Selecting another one of the searches preferably comprises selecting the other search randomly.

Assigning to the stalled search a new set of parameter values based on the selected other search preferably comprises assigning a parameter value set corresponding to a location in the search space that lies on the search space path of the other search. In particular, this may involve assigning, to the stalled search, a current parameter value set of the other search corresponding to the most recent location in the search space of the other search (e.g. the parameters evaluated against the cost function in the most recent/current search step). The stalled search and the selected search may then evolve independently in subsequent iterations of the optimisation process.

Alternatively, assigning to the stalled search a new set of parameter values may comprise assigning a randomly selected set of parameter values to the stalled search.

Preferably, assigning to the stalled search a new set of parameter values comprises selecting one of a plurality of available assignment strategies and assigning the new set of parameter values using the selected assignment strategy, wherein the assignment strategy is preferably chosen randomly in accordance with respective probabilities associated with the available assignment strategies. The available assignment strategies preferably comprise (a) assigning a set of parameter values based on another one of the searches that has not stalled (e.g. as set out above), and (b) random assignment of a set of parameter values (e.g. as set out above). Thus, different stalled searches may be re-assigned using different approaches, determined randomly.

Preferably, the identifying step comprises evaluating each of the parallel searches, preferably at each optimisation iteration, to identify one or more stalled searches, and performing the step of assigning a new set of parameter values for each identified stalled search.

The optimisation procedure preferably comprises a stochastic optimisation procedure, and may comprise one of: stochastic gradient descent, SGD; simultaneous perturbation stochastic approximation, SPSA; simulated annealing; or a variation of SGD, SPSA or simulated annealing. The optimisation process may update parameters at each iteration in accordance with the relevant update rule of the chosen optimizer.

Evaluating the cost function for a given set of values of the circuit parameters preferably comprises: running the quantum circuit on the quantum computer, including executing quantum computation operations specified by the circuit in accordance with the given set of values of the circuit parameters and measuring an output state of the quantum computer after execution of the operations; and determining a cost function value for the given set of circuit parameter values in dependence on the measured output state. The cost function value may be determined based on (or may be equal to) an expectation value of the output state (determined over multiple runs of the quantum circuit).

The quantum circuit is preferably defined by a sequence of unitary operators, each parameterized by a respective one of the circuit parameters.

Preferably, the optimisation process is performed iteratively until a termination criterion is met, wherein the termination criterion may comprise at least one of: a predetermined number of iterations being executed; a predetermined amount of compute time having elapsed; the optimal cost function value found by the searches not changing between iterations or a change between iterations falling below a threshold.

The method may include initialising the circuit parameters for each parallel search to randomly selected values prior to a first iteration of the optimisation process.

Also disclosed is a method of performing optimisation of a cost function for a variational quantum algorithm, VQA, by a classical optimizer executing on a classical computer, wherein a value of the cost function is dependent on an output of a parameterized quantum circuit when run on a quantum computer, the method comprising, at the classical computer:
performing an optimisation process to optimise the cost function with respect to a set of circuit parameters for the parameterized quantum circuit;
wherein the optimisation process comprises a plurality of parallel searches through the search space of possible sets of values of the circuit parameters;
wherein the optimisation process is performed iteratively and includes, at each iteration, updating a current set of parameter values for each of the plurality of parallel searches based on the cost function in accordance with an optimisation procedure, the current set of parameter values of a search corresponding to a location of the search in the search space, and wherein the optimisation process further comprises, at a given iteration:
   evaluating the cost function for each of the parallel searches based on execution of the parameterized quantum circuit on the quantum computer to obtain a cost value and gradient information corresponding to a current location of the search in the search space;
   identifying a given one of the parallel searches that has stalled based on the gradient information at the current location of the search meeting a stall criterion; and
   assigning to the stalled search a new set of parameter values corresponding to a location in the search space different from the current location of the stalled search, wherein the stalled search is continued in subsequent iterations from the different location based on the assigned parameter values;
the method further comprising, upon termination of the parallel searches, determining a set of circuit parameter values corresponding to an optimal cost function value found by the parallel searches; and
outputting the determined set of parameter values.

The method in this example may comprise the further steps or features of any method as set out above.

Also disclosed are a hybrid computer system comprising a quantum computer and a classical computer and adapted to perform any method as set out herein and a non-transitory computer readable medium comprising software code adapted, when executed by a data processing system, to perform any method as set out herein.

More generally, there is disclosed a system having means, optionally comprising a processor and associated memory, for performing any method as set out herein.

Features of one aspect or example may be applied to other aspects or examples, in any combination. For instance, method features may be applied to system or computer program aspects or examples (and vice versa).

### BRIEF DESCRIPTION OF THE FIGURES

Certain embodiments of the invention will now be described by way of example only, in relation to the Figures, wherein:

FIG. 1 illustrates operation of variational quantum algorithms (VQAs) using a quantum computer and a classical optimizer;

FIG. 2A illustrates a parameterised quantum circuit;

FIG. 2B illustrates the optimization loop of a VQA;

FIG. 3 illustrates barren plateaus in the search space explored by the classical optimizer;

FIG. 4 illustrates exploration of the search space using a modified classical optimizer;

FIG. 5 illustrates an optimization process according to embodiments of the invention;

FIGS. 6A-6B illustrate experimental evaluation results using synthetic cost functions;

FIGS. 7A-7B illustrate examples of highest and lowest-ranked functions identified in the evaluation;

FIG. 8 illustrates a weighted graph used for experimental evaluation of the system applied to the Max-Cut problem;

FIGS. 9A-9B illustrates experimental evaluation results for the Max-Cut problem; and

FIG. 10 illustrates a hybrid quantum-classical computing system for implementing described techniques.

### DETAILED DESCRIPTION

Variational quantum algorithms (VQA) are a class of quantum algorithms that use quantum circuits to solve optimization problems, and have shown great potential in various applications. For example, VQAs have been used for Quantum Machine Learning based on various distributions (e.g. MNIST dataset) and Quantum Optimization problems based on graphs (for example the Max-Cut problem can be solved with a VQA called the Quantum Approximate Optimization Algorithm (QAOA)).

An aim underlying the described techniques is the development of the VQA class of algorithms to better use the limited Noisy Intermediate-Scale Quantum (NISQ) computer hardware that is currently available (and to which quantum computing is expected to be limited in the near term at least). For example, two core limitations of such NISQ systems are (1) that they are intermediate scale, which limits the available compute resources (e.g. number of qubits; total number of gates implementable; number of qubits over which gates can operate and so forth) and (2) that they are noisy, leading to a practical limit on circuit depth (number of consecutive gates acting on qubits), and resulting in cost function landscapes that are difficult to search efficiently.

The described optimisation techniques, by allowing more effective exploration of the search space, can result in improved approximations, faster convergence of the hybrid quantum-classical optimization process, and improved overall performance, thereby expanding the applicability of VQAs to a wider range of NP-Hard optimization problems.

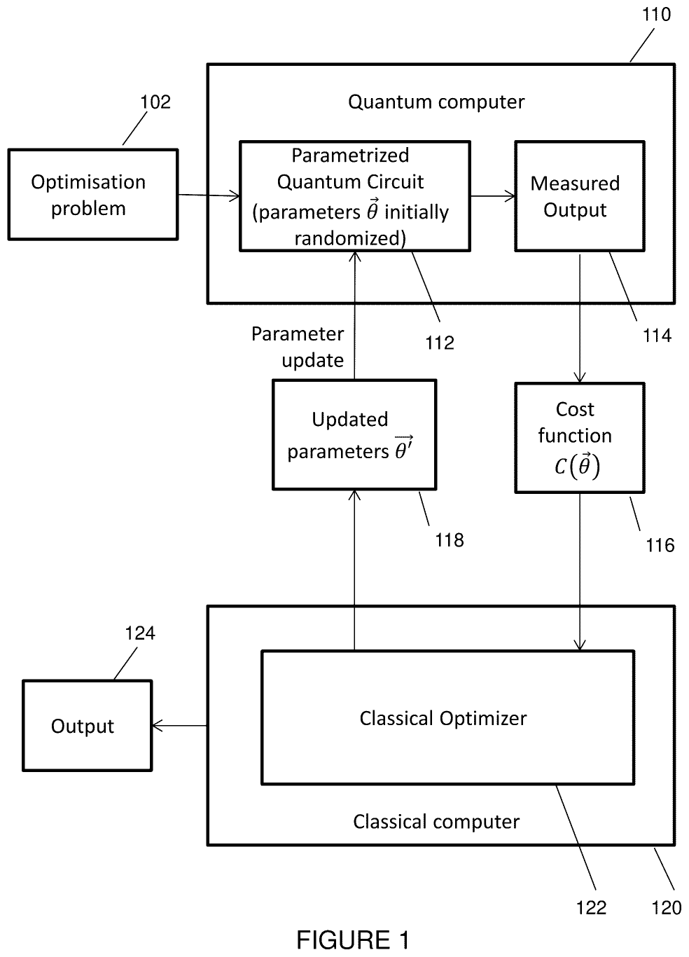

FIG. 1 illustrates in overview the operation of VQAs in a hybrid quantum/classical computing environment. In a VQA, an optimisation problem 102 is represented as a quantum circuit 112 which is parameterised by a set of quantum circuit parameters \vec{θ}. For example, depending on the problem being solved, this may involve encoding classical data such as a distribution or graph to a parametrized quantum circuit. Initial parameter values for the quantum circuit may be selected randomly, or may be initialized in some other way.

Optimization is based on a classical optimizer 122 (running on a classical computer 120) optimizing those circuit parameters with respect to a cost function 116. The form of the cost function is dependent on the optimisation problem being solved. However, while the optimizer itself is a classical algorithm running on a conventional computer, the evaluation of the cost function involves running the parameterized quantum circuit 112 on a quantum computer 110, with the quantum processing transforming the original state to a parametrized state. An output state 114 of the quantum computer is then measured, typically in terms of the expectation value of some observable or set of observables (for example Hamiltonian or some other Hermitian operator). The expectation value is obtained by running the quantum circuit a number of times and obtaining an average of the measured output. The determined expectation value corresponds to the cost value of the cost function for the particular set of values of the circuit parameters being evaluated (\vec{θ}).

The expectation value is provided as the cost function value for the parameter set \vec{θ} to the classical computer 120 for use in a classical optimisation procedure 122 using first order methods (for example stochastic gradient descent) with the goal of optimising the quantum circuit parameters with respect to the cost function. Each search step of the optimizer involves updating the current parameters \vec{θ} based on the gradient information of the cost function, using the relevant update rule of the optimizer being used (for example, in gradient descent-based methods this may generally involve updating the parameters in the direction of the steepest gradient by some amount determined by a learning rate). The updated quantum circuit parameters 118, corresponding to a different location in the parameter space, are then fed back to the quantum computer to form an updated circuit 112. With each classical optimisation step the updated circuit can be expected to give a better value (closer to the true value) for the expectation value. This loop is repeated until a stable point is found (e.g. changes in the quantum circuit parameters between successive loops drop below a chosen threshold), at which time a final output 124 is produced.

This approach can use relatively simple optimisations, leveraging the high throughput of modern high-performance computers, meaning that each iteration of the loop can be reasonably fast to execute. However, given the typical nature of the cost function landscape, the search performed by the classical optimizer is prone to finding local minima or stalling at barren plateaus, which are locations in the search space where the gradients vanish.

Vanishing of gradients refers to the magnitude of the gradient vector being zero or taking noisy values around zero (e.g. being within a threshold distance of zero). One way of addressing this involves running the classical optimizer 122 repeatedly, but the high prevalence of barren plateaus in typical VQA cost functions can mean that many runs may be needed, without any guarantee that a global optimum will be found.

Note that examples described herein assume that the optimization involves minimizing a cost function, but it could equivalently involve optimizing any form of objective function, e.g. maximizing a performance function.

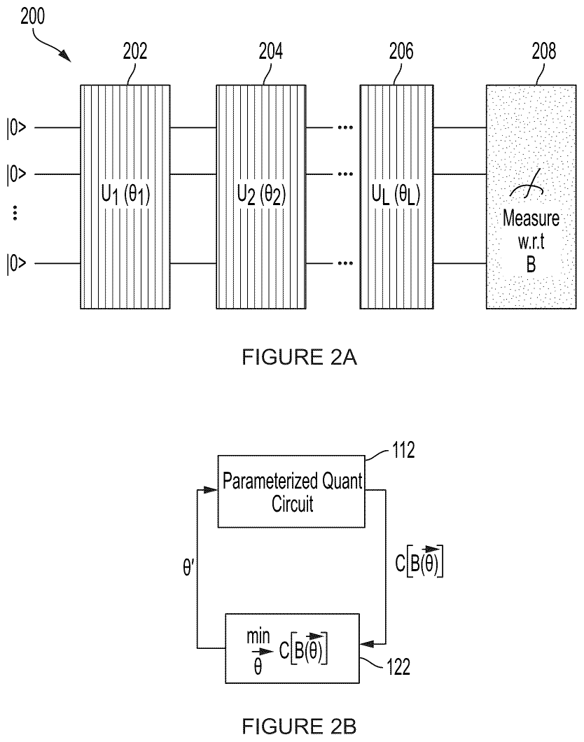

FIG. 2A illustrates an example of a parameterized quantum circuit which has the form of a set of unitary operators (202-206), U₁(θ₁) . . . . U_{L}(θ_{L}) applied sequentially with varying parameters θ to an initial state, |s [symbol] .

In this context, “quantum circuit parameters” refer to data relating to the encoding of qubits, connectivity between qubits, arrangements of gates for manipulating the qubit states, and so forth. Also, in the context of post quantum cryptography, the parameters may relate to circuits where free parameters that can be tuned in a certain way are allowed (i.e. they are not pre-fixed as in the case of fault tolerant algorithms).

The quantum processing results in transformation of the original state to a new parameterized state. After the quantum circuit operations 202-206 have been performed, the quantum computing system performs a measurement 208 to measure some observable B=B(\vec{θ}) which is a function of the parameters \vec{θ}ϵ [symbol] ^{L} and which defines a cost function C[B(\vec{θ})].

Note that a generic formulation of the cost function is used here since its precise form depends on the original optimisation problem and the user is free to define and encode it as required for the problem being solved. Typically, the cost function is some real function of interest that is being encoded onto a quantum observable as, e.g. some polynomial operator on the Pauli matrices.

In general, costs in a VQA problem encoding may be thought of as a multidimensional hypersurface, referred to as the cost landscape, with the optimisation procedure seeking a global optimum, i.e. the minimum of the cost function hypersurface (or maximum if a function is being maximized). A general form of the cost function is:

C(\vec{θ})=ƒ({ρₖ}, {Oₖ}, U(\vec{θ}))

in which ƒ is some function, U(\vec{θ}) is a parametrised unitary, \vec{θ} is composed of discrete and continuous parameters, {ρₖ} are input states from a trailing set and {Oₖ} are a set of observables. This can conveniently be expressed in the form:

$$C ( \vec{θ} ) = {\sum }_{k} {f}_{k} ( Tr [ {O}_{k} U ( \vec{θ} ) {ρ}_{k} {U}^{†} ( \vec{θ} ) ] )$$

FIG. 2B illustrates the feedback loop of the VQA between the classical optimizer and the quantum computer, in which the cost function, which depends on the measured output state of the parameterized quantum circuit 112, is optimised for \vec{θ} by the optimizer 122. As shown in FIG. 1, the optimizer runs on a classical computer using a classical optimisation algorithm such as stochastic gradient descent (SGD), simultaneous perturbation stochastic approximation (SPSA), simulated annealing or variants of those or similar algorithms. The optimisation minimizes the cost function with respect to the circuit parameters:

$${min}_{\vec{θ}} C [ B ( θ ) ] .$$

The optimisation produces at each search step updated parameters \vec{θ}′ which are fed back to the original quantum circuit 112, which is then re-run using the updated parameter values. The optimisation loop of FIG. 2B is repeated as many times as required. For example, the process may be repeated until some convergence criterion is met, which may correspond to reaching a stable point (e.g. when the parameters stop changing between iterations or changes fall below some threshold) such that the solution is no longer improving. Alternatively or additionally the process may limit the optimisation to a predetermined number of iterations or a predetermined total compute time. The precise termination criteria may be selected by the user and may be problem dependent. With reference to FIG. 1, once the optimisation loop ends, the final set of updated parameters \vec{θ}′ form the final output 124 of system and represent the solution to the original optimisation problem 102.

In typical VQA implementations, multiple iterations of the classical optimizer are performed as is common in stochastic optimization (e.g. ADAM or SPSA). After m iterations of the classical optimizer, the best solution (with lowest cost value) found is then selected as the final output.

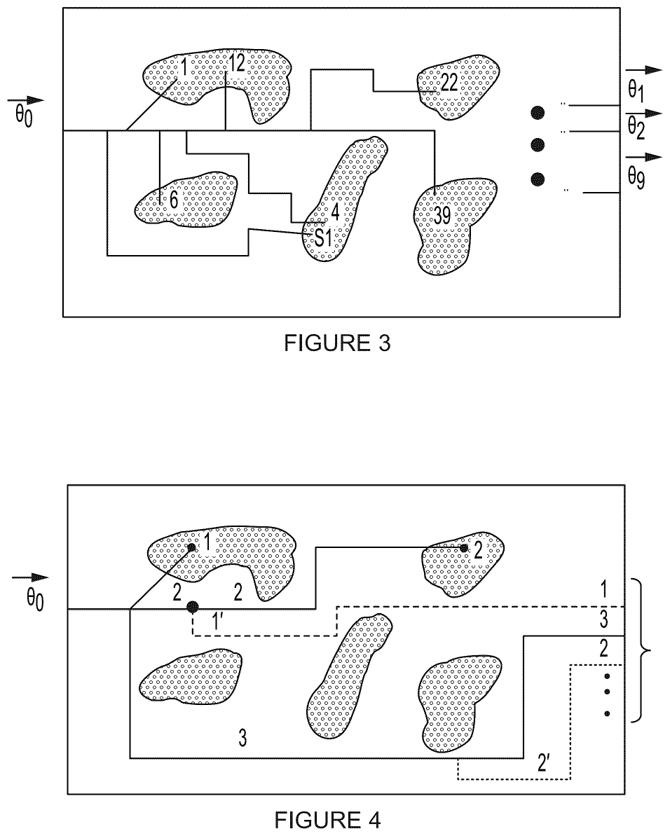

As noted above, a problem with standard optimization techniques is that any given run of the optimizer may effectively stall by reaching a barren plateau, a flat region where the gradient of the cost function vanishes (but which may be far from the global optimum). A simplified 2D illustration of a search space explored by the optimizer is shown in FIG. 3. In FIG. 3, shaded regions are barren plateaus where the gradient of the cost function vanishes, preventing the optimizer from making progress, since the optimizer relies on gradient information of the cost function to compute the updates to the parameter set at each iteration.

Using conventional approaches, the optimizer is run repeatedly to perform i=1 . . . m searches in the parameter space, starting from some initial parameter vector \vec{θ}₀. In the illustrated example, a number of those searches (the iterations labelled 1, 4, 6, 12, 22, 39 and 51) have reached barren plateaus and thus have stalled. As a result, only a subset of the searches ultimately produces useful output solutions (labelled as \vec{θ}₁ . . . \vec{θ}_{q}, where q<m).

As already noted, due to the noisy nature of currently available quantum computer hardware, especially NISQ (Noisy Intermediate-Scale Quantum) type quantum computers, the cost function landscape typically exhibits many such regions, increasing the chance of the optimizer stalling, which can significantly reduce the efficiency and optimality of the classical optimization. As a result, many more iterations of the classical optimizer 122 may need to be run and/or the process may ultimately arrive at a less optimal (higher cost) final output.

FIG. 4 illustrates an alternative optimization approach implemented in accordance with embodiments of the invention. In this approach, the optimizer runs n searches in parallel. Each search is referred to as a “particle”, where each particle represents a different instance of a stochastic optimizer of choice. The particles may use any suitable known algorithm such as stochastic gradient descent, SPSA or Simulated Annealing to determine the gradient-based updates at each search step.

Specifically, at each particle iteration of the optimizer, a search step is carried out for each of the n particles. This involves updating the parameter set \vec{θ}ᵢ for each of the particles (i=1 . . . n) based on local gradient information, in accordance with the standard update rule for the optimization algorithm being used. In this way, each particle evolves a parameter set \vec{θ}ᵢ from some initial location in the search space to a final location based on gradient information of the cost function. The current state of each of the particles, i.e. the current location of a particle in the search space, is determined by the current parameter set \vec{θ}ᵢ of that particle. The non-deterministic, stochastic nature of the search means that the optimizer causes the n particles to evolve along different paths through the search space in parallel as the search progresses. Note that the search space may also be referred to as the parameter space.

The “parallel” nature of the searches merely refers to the fact that the optimizer does not complete one search before starting another, but rather performs a search step for each of the n particles at a given iteration of the optimizer. While this could be achieved through parallel processing (e.g. using multiple CPUs/CPU cores or parallelized accelerator hardware) this is not required and the parallel searches could be implemented using sequential processing by an inner loop that iterates over each particle, performing a search update for each particle in turn, for every search step of the optimizer.

At each iteration of the search, once updated parameter sets have been computed for all the particles, each particle is evaluated to determine if it has stalled by reaching a barren plateau, where the disappearing gradients of the cost function would prevent the particle from progressing to a more optimal location in the search space. Any stalled particle is then reinitialised at a new location in the parameter space. In one approach, each stalled particle is reinitialised at the current location in the search space of another one of the particles. For example, in FIG. 4, after a certain number of search iterations, particle 1 has arrived at a plateau and is reinitialised at the location of another particle, in this case particle 2. Whilst at that point, particles 1 and 2 occupy the same location in search space, due the non-deterministic nature of the optimisation algorithm, the paths taken by the particles through the search space can be expected to diverge subsequently. The new path for particle 1 is shown as 1′. In the depicted example, at some later stage of the optimization, particle 2 also arrives at a plateau and is reinitialised at the corresponding location of particle 3 before following new path 2′. This approach allows the optimizer to escape the barren plateaus and continue making progress towards a more optimal solution for each particle. Reinitialization based on another particle is also referred to as the exploitation strategy for particle reinitialization.

As an alternative to reinitialising a particle to the location of another particle, any stalled particle may be reinitialised to a randomly selected point in parameter space (i.e. a random set of \vec{θ}ᵢ parameters). This is referred to as the exploration strategy. In one approach, the options of reinitialising the stalled particle to another particle location or to a randomly selected point are both available and a strategy may be selected for a given stalled particle based on a selection criterion or randomly. In a particular example, the algorithm chooses to reinitialise the stalled particle to a random point in search space with a specified probability (e.g. 20%); in all other cases, reinitialization is performed based on the location of a randomly selected non-stalled particle.

These approaches can allow a more thorough exploration of the search space by the optimizer.

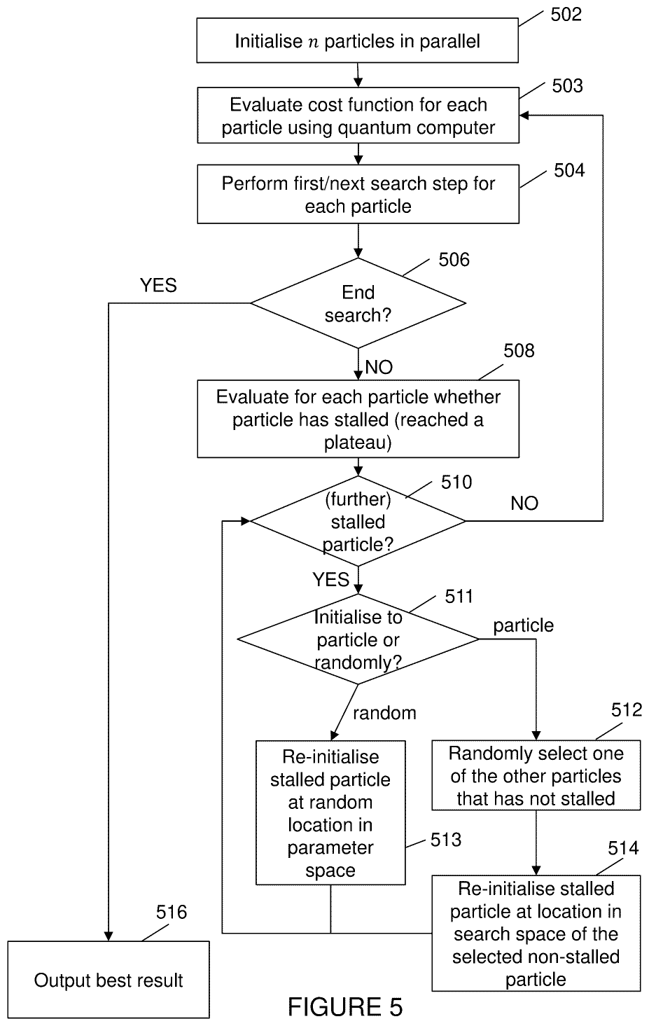

The process is illustrated in FIG. 5.

In step 502, the process starts with initialising n particles in parallel. Each particle is initialised at a randomly selected point in the domain defined as the parameter search space (i.e. with a random set of circuit parameters \vec{θ}).

The optimisation loop starts in step 503 with evaluation of the cost function at the location of each particle. As described above in relation to FIG. 1, the cost function evaluation is performed using the quantum computer. Specifically, this involves (for each particle) parameterizing the quantum circuit 112 using the current parameter values \vec{θ}ᵢ of the particle. The parameterized circuit is run on the quantum computer multiple times, the output 114 is measured and an expectation value of the output is determined over repeated runs to obtain the cost function value for the particle.

At step 504, the optimizer performs the first (or in later iterations, next) search step for each particle in accordance with the update rule of the optimization algorithm used, e.g. by evaluating local gradients of the cost function at the search space location of a particle and determining a change in the parameter values based on the gradients, resulting in an update to the parameters \vec{θ}ᵢ for each particle i. The local gradient of the cost function may be determined, for example, via a two-point function approximation or using the parameter shift rule (PSR), as known to those skilled in the art. The PSR approach essentially corresponds to computing the expectation value we are interested at, at neighbouring parameter values.

At step 506, the process determines whether to terminate the search. For example, the search may be terminated when a certain iteration limit (e.g. 50 optimization steps) has been reached or a certain compute time has elapsed (this could e.g. be actual compute time or absolute time). Alternatively, the search may be terminated once the lowest cost value found is below some threshold or once the lowest cost value is stable (e.g. no or minimal improvement over the last iteration or over the recent iteration history). The termination criterion applied in step 506 (which may combine any of the above criteria) may be a configurable hyperparameter of the algorithm (e.g. a configurable iteration limit).

Assuming the termination criteria are not fulfilled (NO branch), the process then evaluates each particle in step 508 to determine whether the particle has reached a barren plateau and so this particular branch of the search has stalled. In an implementation, if the gradient (specifically the magnitude of the gradient vector) of the cost function is zero (or close to zero e.g. within a threshold distance from zero) at the particle location, then the particle is considered to have reached a plateau. In one implementation, the stall criterion determines that a particle has stalled based on the average gradient norm computed on a recent window of optimising steps. If the average gradient norm (or magnitude) over a given number of optimising steps is below some threshold, then the particle is deemed to have stalled.

Any stalled particles are then processed in a loop 510-514 as follows. For each stalled particle, the process determines (511) whether to reinitialise the particle randomly (exploration strategy) or based on one of the other particles (exploitation strategy). This determination may itself be made randomly e.g. by assigning different probabilities to the options, for example 20% probability for a fully random reinitialization versus 80% probability for reinitialization based on another particle. The probability determining which strategy is used may be referred to as the exploration rate parameter.

In the case of reinitialization based on another particle (511 branch “particle”), the process randomly selects one of the other particles that has not stalled in step 512 (i.e. a particle that has not arrived at a barren plateau). The stalled particle is then reinitialised (514) along the trajectory of the selected particle. In a preferred approach, the stalled particle is reinitialised at the current location of the selected particle (as determined in the most recent search step) by setting the parameters \vec{θ} of the stalled particle to the corresponding parameter values of the selected particle (alternatively, instead of the current location, the particle could be reinitialised at an earlier location along the search path of the selected particle). This results in one of the n particles being shifted in the search space to the current location of another particle. Optionally, to improve search space coverage, if there are multiple stalled particles, the process may select, for each stalled particle, a different random one of the non-stalled particles to provide the parameter space location for reinitialising the stalled particle.

If the process selects fully random reinitialization (511, branch “random”), then the stalled particle is reinitialised in step 513 at a random location in the parameter space (by selecting a random set of parameter values 6).

After reinitialization (513 or 514) the process returns to 510 to determine whether there are further stalled particles to reinitialise.

Once all stalled particles have been reinitialised (510, NO branch), the process iterates to step 503 to repeat the optimization loop by evaluating the cost function at the updated particle locations and performing the next search step for each particle. Any reinitialised particles continue the search from their new locations in the search space but may then evolve independently from the particle whose location they adopted due to the non-deterministic nature of the stochastic optimization algorithm.

Once the termination criterion for the optimisation is met (506, YES branch), the optimization ends. The process then outputs the best result in step 516, i.e. the set of circuit parameters \vec{θ} corresponding to the lowest value of the cost function observed during the optimisation history.

The lowest value may typically correspond to the location of one of the particles at the end of the optimization loop. However, the process may also remember the locations and cost values of any stalled particles (or just the lowest-cost one). Thus, in the event that one of the stalled particles actually represented the lowest-cost result found during the optimisation, its parameters \vec{θ} can the then be used as the final output of the optimisation.

Note that while the optimisation could be performed with a fixed learning rate, in some implementations, the learning rate may change over time. For example, the learning rate may decrease over time (e.g. at each iteration) from some starting value. In that case, when a particle is reinitialised to the location of another particle, its learning rate may be reset to the starting value to encourage faster divergence from the other particle.

The described approach can increase the efficiency of the parameter space search compared to m optimizers that are not evaluated for stall. By resetting stalled particles at more promising or random locations in the search space, the system can bias the optimizer gradient updates towards paths in the parameter space which avoid barren plateaus. As a result, a greater proportion of the search space can be explored by the optimizer. As noted, this can be particularly beneficial for VQA algorithms running on noisy quantum hardware, where the noise contributes to a cost function landscape that can be challenging to navigate for conventional algorithms.

While the FIG. 5 example combines both random reinitialization and initialization based on a non-stalled particle, the process could be limited to use only one or the other approach for reinitialization. Which approach to use and/or the selection probabilities of each reinitialization strategy (which e.g. could depend on the function characteristics at the position of the non-stalled particles) may be configurable hyperparameters of the algorithm.

The described techniques are applicable to various forms of VQA, including but not limited to the Variational Quantum Eigensolver (VQE) and the Quantum Approximate Optimization Algorithm (QAOA).

The following sets out a more detailed example of an implementation of the above algorithm in pseudo-code (note that here the reinitialization of a particle is referred to as “regeneration after absorption”, reinitialization to a random location is referred to as “reinitialization”, and reinitialization to another particle is referred to as “reactivation”; finally, the stall criterion is referred to as the “absorption condition”).

Algorithm Parallel optimization algorithm

Require: T : the number of classical optimization iterations,

```
        N : the number of optimizer particles,
        B: the burn-in time steps used to compute the reference gradient norm involved in the
particle's absorption condition,
        W : the size of the time window on which the average gradient is computed,
        α: the relative gradient threshold for absorption of a particle,
        ε: the exploration rate.
```

Ensure: Estimate of the parameter vector minimizing the system energy:

| | |
|---|---|
| 1: | avg_abs_gradient ← 0 |
| 2: | for i = 1 to B do |
| 3: | OPTIMIZEANDRECORDGRADIENT |
| 4: | Update avg_abs_gradient |
| 5: | end for |
| 6: | ref_gradient ← α × avg_abs_gradient |
| 7: | for i = 1 to T do |
| 8: | OPTIMIZEANDRECORDGRADIENT |
| 9: | CHECKABSORPTIONANDREGENERATEPARTICLES |
| 10: | end for |
| 11: | procedure OPTIMIZEANDRECORDGRADIENT |
| 12: | for j = 1 to N do |
| 13: | Perform optimization step for particle j |
| 14: | Record observed gradient for particle j |
| 15: | end for |
| 16: | end procedure |
| 17: | procedure CHECKABSORPTIONANDREGENERATEPARTICLES |
| 18: | for j = 1 to N do |
| 19: | if avg gradient of particle j over last W steps < ref_gradient then |
| 20: | rnd ~ U[0, 1] |
| 21: | if rnd < ε then |
| 22: | REINITIALIZEPARTICLE(j) |
| 23: | else |
| 24: | REACTIVATEPARTICLE(j) |
| 25: | end if |
| 26: | end if |
| 27: | end for |
| 28: | end procedure |
| 29: | procedure REINITIALIZEPARTICLE(j) |
| 30: | Regenerate particle j to a randomly chosen point in the parameter space |
| 31: | Reset the history of recorded gradient values for particle j |
| 32: | end procedure |
| 33: | procedure REACTIVATEPARTICLE(j) |
| 34: | Regenerate particle j to a randomly chosen particle (r) among non-absorbed particles |
| 35: | Assign the last W gradient values of particle r as the last W gradient values of particle j |
| 36: | Reset the learning rate of particle j to the initial learning rate of particle r with the goal of |
| | increasing the divergence between the two particles, thus boosting exploration |
| 37: | end procedure |

### Evaluation

As the described parallel particle-based optimiser was loosely inspired by the Fleming-Viot (FV) stochastic process used to model biological evolution, it is referred to in the following discussion as the FV-based parallel optimizer.

We analyzed the FV-based parallel optimizer using simulated annealing (SA) as each particle's optimizer, because of a good balance between simplicity and power. The experiments were run against a benchmark defined by using SA as a single optimizer on as many ansätze (initial parameter values) as the number of particles used in the FV-based parallel optimizer. The values of the ansätze in the SA run and in the FV-based run are the same, so that both optimizers start at the same locations in the parameter space.

We carried out two sets of experiments, each under a different optimization scenario; concretely:
1. a two-dimensional optimization on synthetic cost functions generated with a pre-defined level of barren areas;
2. a multidimensional optimization using VQA on the Max-Cut problem.

Each set of experiments is defined by a parameterization that is specific to the optimization problem to be solved. Results are collected and summarized over 10-replication runs on each experiment.

Of particular interest is the analysis of the effect of the exploration rate parameter (which dictates the probabilities for selection between reinitialization of a stalled particle either randomly or based on the location of the other particles). Thus, in each of the two optimization scenarios, two exploration rates were considered: 50% and 100%. In the latter case, all absorbed particles are reinitialized under the exploration strategy described above (i.e. random reinitialization).

### Synthetic Experiments

Each synthetic experiment is defined by an expected percentage of barren plateau presence in the optimization landscape whose domain is set as the two-dimensional rectangular area [0,1]×[0,1]. The synthetic function is constructed as the output of a smoothing spline interpolation on a set of (x, y, ƒ) points, using the procedure described below.

Table 1 lists the most important simulation parameters for the synthetic experiments.

TABLE 1

| Parameter | Possible values | Values used |
|---|---|---|
| Domain | bounded domain in [symbol] ² | [0, 1] × [0, 1] |
| Barren percent | 0%-100% | 70% |
| Gradient absorption value | ≥0 | 1.0 |
| Exploration rate | 0%-100% | 50%, 100% |
| Number of particles | ≥2 | 10 |

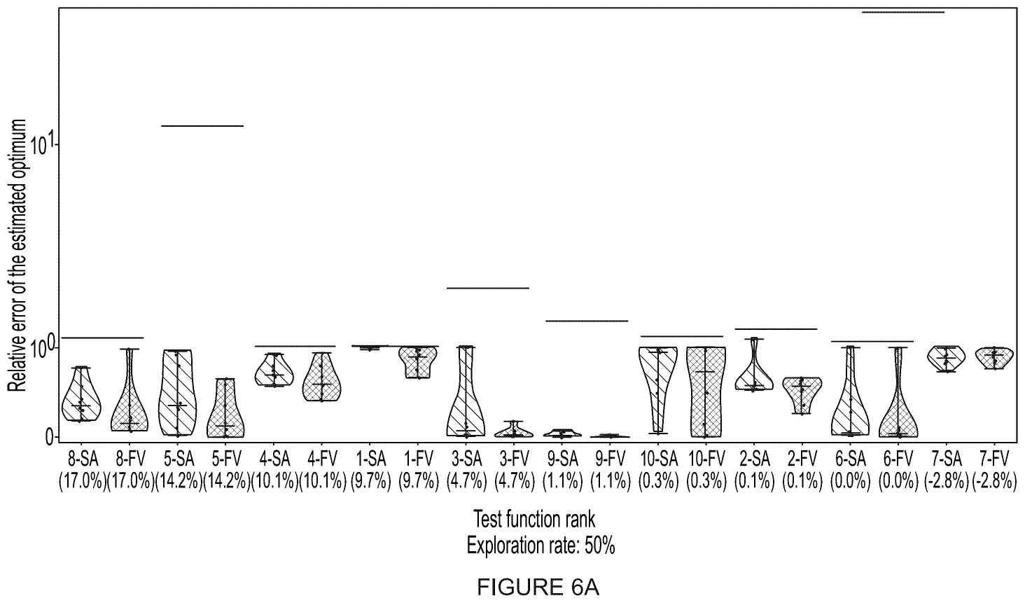

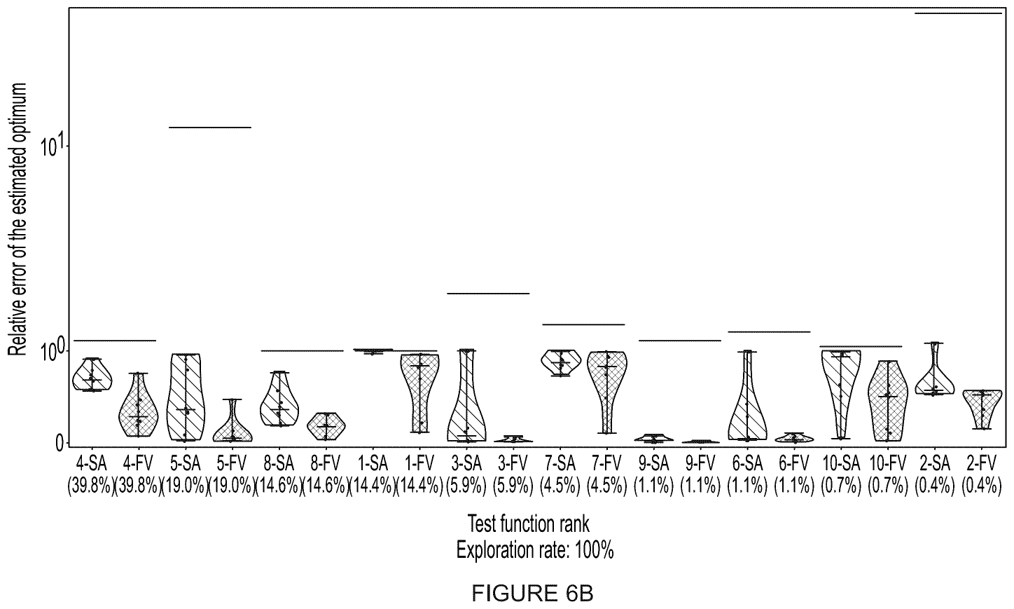

FIGS. 6A and 6B show the results of the experiments carried out on 10 synthetic functions for two different exploration rates: 50% (FIG. 6A) and 100% (FIG. 6B). In more detail, results are shown as violin plots on 10 replications of the relative error (log scale) of the optimum value found for 10 synthetic functions having approx. 70% of barren areas. Violin plots are paired by the respective synthetic function and those pairs are sorted by decreasing observed advantage of FV over SA (where the advantage is indicated in parenthesis and measured as the difference of the two medians in each pair relative to the worst possible error marked as a horizontal gray line at the top of each pair and computed as the relative error of estimating the maximum function value as the optimum). The labels below each group (e.g. “3-SA, 3-FV”) indicate the function ID associated to the optimization problem and the method used, so that it is possible to compare the results on a particular function obtained by the two exploration rates (red: SA; green: FV). The number of optimization steps run per particle is 50. Lower position of the violins is better.

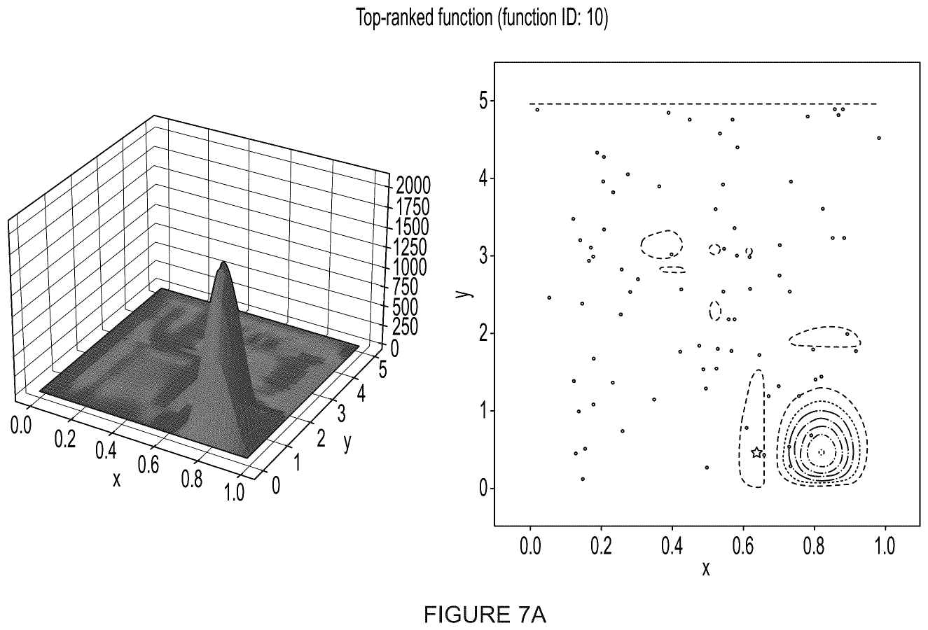

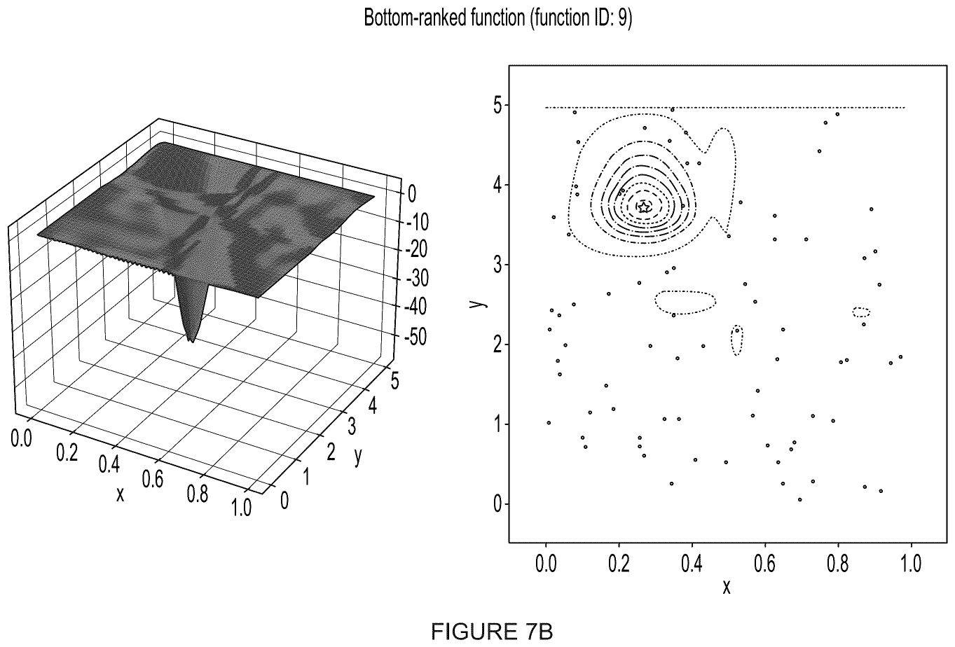

FIGS. 7A-7B show the landscape of the top (FIG. 7A) and the bottom (FIG. 7B) functions as ranked by the results of the 100% exploration rate case (FIG. 6B). In each case, the 3D landscape is shown on the left and the corresponding contour plot on the right. In the right plot red points show the 100 ansätze (=10 particles×10 replications) used in the optimization process and the red cross indicates the location of the global minimum.

We observe that the landscape where the FV optimization most outperforms the SA optimization corresponds to a landscape where the global minimum is found at a shallow position w.r.t. the barren plateaus, whereas the FV optimization performs similarly to SA when the global minimum is located at a very steep valley.

The following procedure was used to generate the synthetic functions used as test bench of the proposed optimization algorithm. Given:
the 2D rectangular parameter domain on which the synthetic function will be generated (e.g. [0,1]×[0,1]),
the number of grid points to consider in each dimension on which the value of the function ƒ will be generated (e.g. 100 points),
the nominal number of desired barren plateaus,
the nominal width (number of grid points), in each parameter dimension, of each barren plateau to be generated,
the width of the border margin, i.e. the margin to leave between the border of the domain and the barren plateaus (e.g. 2 grid points),
the smoothing parameter for the smoothing spline interpolation that is used to define the value of the function ƒ in each grid point (e.g. 1),
the synthetic process consists of the following iterative steps:
   1. Set the value of the function at the grid points in the border margin to a value a little larger than 1 (e.g. 2), so that the global minimum of the function is less likely to be located at the border, which is an unwanted situation because it artificially helps the optimization algorithm find the global optimum. This aid is due to the fact that the parameter estimate at each optimization step is clipped to the domain. Therefore, if after a particular step the parameter estimate happens to fall outside the domain, its location might end up being close to the global optimum just because of clipping.
   2. Randomly sample a point among the grid points in a subset of the domain that guarantees there is no overlap between the barren plateaus and the border margin; this point represents the center of a barren plateau.
   3. Construct a square centered at the sampled point, which represents the new proposed barren plateau.
   4. Sample a value from a uniformly distributed random variable in [0, 1] that represents the proposed constant value of the optimization function at each grid point of the barren plateau.
   5. Check overlap between the newly constructed square and other barren plateaus previously constructed. If there is overlap, regions are merged into a single barren area. The function values assigned to each point in each of the regions before merging is maintained.
   6. Compute the barren plateau percentage as the percent of grid points in the barren areas constructed so far and the total number of grid points in the domain. If this percentage is smaller than the expected percentage of barren plateau, go to step (2).
   7. Sample a value from a lognormal distribution with zero mean and a specified scale parameter (e.g. 1). Set the negative of this value to the function value at a randomly selected point in the grid, where the global minimum of the function is expected to be located.
   8. Fit a 2D smoothing cubic spline (using the chosen smoothing parameter) to all the sampled function values: (i) the values assigned to the grid points in all generated barren plateaus, (ii) the value assigned to the grid points at the four borders of the domain, (iii) the negative function value representing the expected global minimum. The smoothing spline fit is used to assign a function value to each grid point in the domain. Note: due to the smoothing spline fit, the location and value of the global minimum may not be the same as the selected values in step (7). If the location of the global minimum is at the border of the domain, the synthesized function is discarded and the whole process described here is run again until the global minimum falls in an interior point of the domain.

### QAOA Experiments

The Quantum Approximate Optimization Algorithm (QAOA) is a VQA proposed to solve combinatorial optimization problems. In this subsection we present the results of running QAOA experiments on the 8-node Max-Cut problem.

Table 2 shows the main parameters used in the Max-Cut experiments:

TABLE 2

| Parameter | Value |
|---|---|
| Number of qubits | 8 |
| Level of connectedness | 100% |
| Weights on graph edges | Uniform dist. |
| Number of layers p | 1 |
| Noise | False |
| Noise parameter | N/A |
| Gradient absorption value | 1.0 |
| Exploration rate | 50% and 100% |
| Number of particles | 10 |

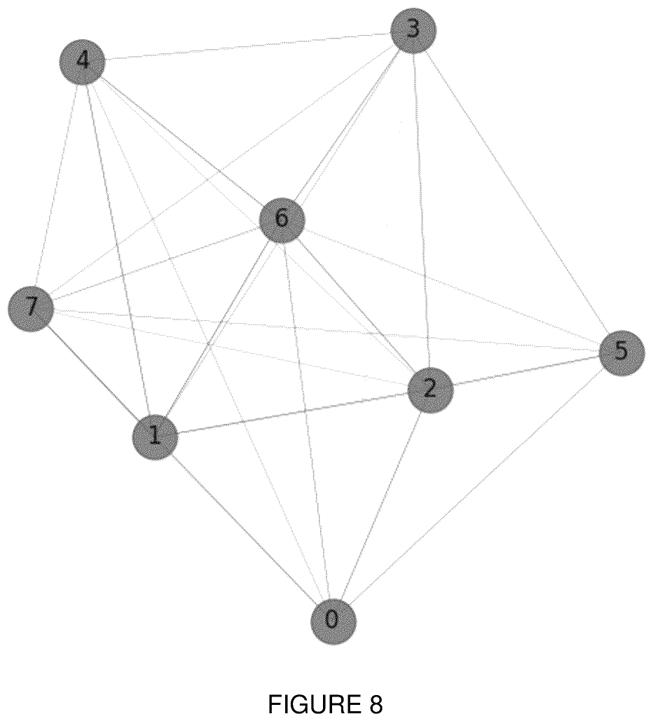

FIG. 8 shows the graph used in the problem, illustrating a fully-connected 8-node weighted graph of the analyzed Max-Cut problem, where the edge width is proportional to the weight value which follows a uniform distribution in [0, 1].

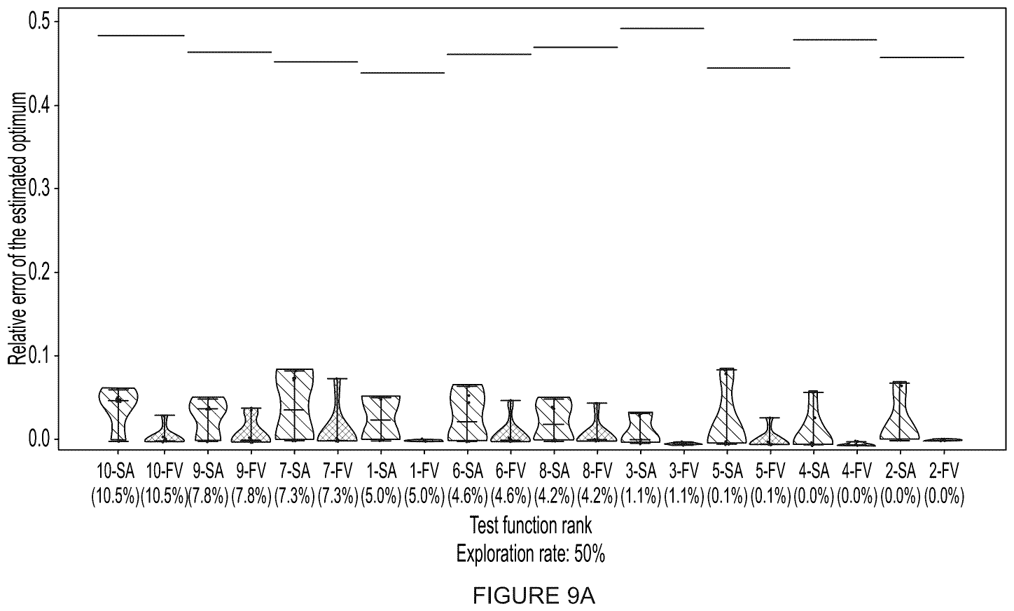

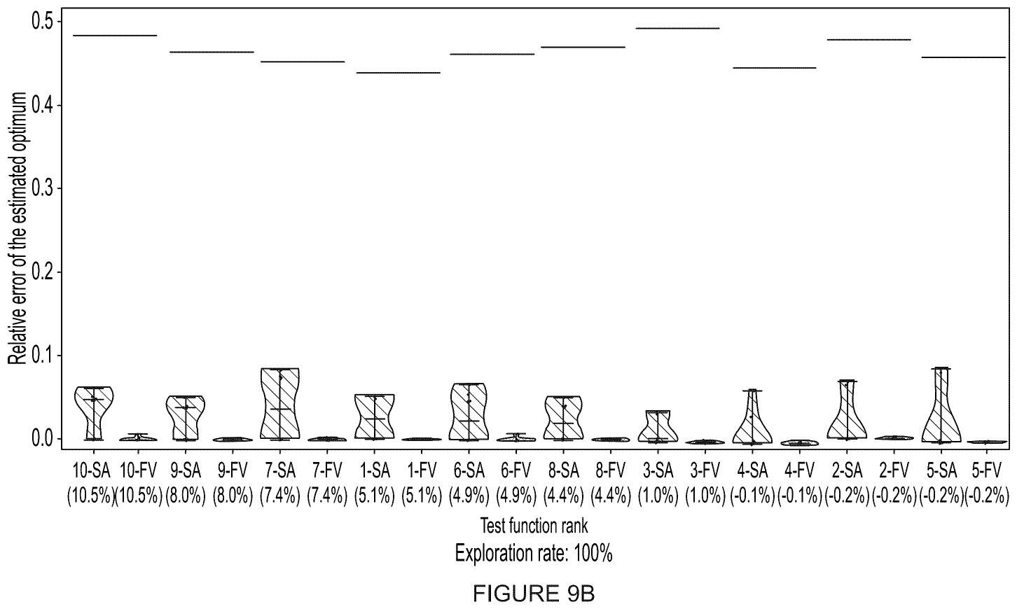

FIGS. 9A and 9B present the relative error of the maximum value found by the two optimization algorithms compared: SA and FV. Specifically, FIGS. 9A-9B show violin plots on 10 replications of the relative error of the optimum value found for the Max-Cut problem on a fully-connected 8-node graph with edge weights chosen uniformly at random between 0 and 1. The results are shown for 10 different test graphs. Each of the figures corresponds to a different exploration rate. In each figure, violin plots are paired by the respective optimization function and those pairs are sorted by decreasing observed advantage of FV over SA (where the advantage is indicated in parenthesis and measured as the difference of the two medians in each pair relative to the worst possible error marked as a horizontal gray line at the top of each pair and computed as the relative error of estimating the maximum function value as the optimum). The labels below each group (e.g. “3-SA, 3-FV”) indicate the function ID associated to the optimization problem and the method used, so that it is possible to compare the results on a particular function obtained by the two exploration rates (red: SA; green: FV). The number of shots for the evaluation of the quantum circuit is 512. The number of optimization steps run per particle is 50. Lower position of the violins is better.

### Example Processing System

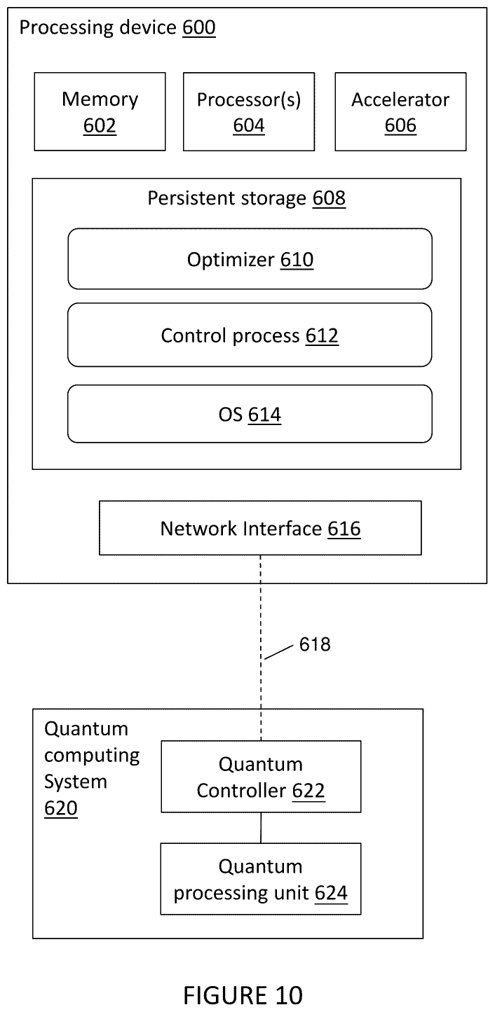

The described techniques may be implemented using a hybrid computer system including classical and quantum processing devices. Example processing devices for such a system are illustrated in FIG. 10.

Classical processing device 600 may be based on conventional workstation or server hardware and as such includes one or more processors 604 together with volatile/random access memory 602 for storing temporary data and software code being executed. Accelerator hardware 606 (e.g. a GPU) may optionally be provided to provide hardware acceleration for the optimisation algorithm.

Persistent storage 608 (e.g. in the form of hard disk storage, optical storage and the like) persistently stores software and data for performing various described functions. In an example, this includes an optimizer module 610 for performing the classical optimization algorithm (described in relation to FIG. 5) and a control process 612 for controlling interaction with the quantum computer to evaluate the cost function for sets of parameter values \vec{θ} at each search step of the optimizer.

The persistent storage further includes a computer operating system 614 and any other software and data needed for operating the processing device.

A network interface 616 is provided for communication with other system components. For example, the processing device may communicate via the network interface with the external quantum computing system 620. Communication may occur over one or more networks 618 (e.g. Local and/or Wide Area Networks, including private networks and/or public networks such as the Internet).

The device will include other conventional hardware components as known to those skilled in the art, and the components are interconnected by one or more data buses (e.g. a memory bus and I/O bus).

The quantum computing system 620 includes a quantum controller 622 which provides the control interface to a quantum processing unit 624. The quantum controller receives the parameterized quantum circuit via network 618, executes the circuit, obtains measurements of the quantum system and provides outputs based on the measurements back to the processing device 600.

In an embodiment, the quantum computing system may be provided as a remote system, accessible via a cloud-based quantum computing service. In other embodiments, the quantum computing system may be locally connected to the processing device via a network or peripheral connection interface, or may be integrated into the processing device 600.

The quantum computer may be any suitable quantum computer, such as an IBM Osprey or other IBM quantum computer, a Rigetti Aspen M-2 system etc.

While a specific architecture is shown and described by way of example, any appropriate hardware/software architecture may be employed to implement the hybrid computer system. Furthermore, functional components indicated as separate may be combined and vice versa.

It will be understood that the present invention has been described above purely by way of example, and modification of detail can be made within the scope of the invention.

1. A method of executing a variational quantum algorithm, VQA, using a hybrid computer system comprising a quantum computer and a classical computer, the method comprising:
receiving information defining a quantum circuit, wherein the quantum circuit is parameterized by a set of circuit parameters;
performing, using the classical computer, an optimisation process to optimise a cost function with respect to the circuit parameters, wherein a value of the cost function is based on an output of the parameterized quantum circuit when run on the quantum computer;
wherein the optimisation process comprises a plurality of parallel searches through the search space of possible sets of values of the circuit parameters;
wherein the optimisation process is performed iteratively and includes, at each iteration, updating a current set of parameter values for each of the plurality of parallel searches based on the cost function in accordance with an optimisation procedure, the current set of parameter values of a search corresponding to a location of the search in the search space, and wherein the optimisation process further comprises, at a given iteration:
evaluating the cost function for each of the parallel searches based on execution of the parameterized quantum circuit on the quantum computer to obtain a cost value and gradient information corresponding to a current location of the search in the search space;
identifying a given one of the parallel searches that has stalled based on the gradient information at the current location of the search meeting a stall criterion; and
assigning to the stalled search a new set of parameter values corresponding to a location in the search space different from the current location of the stalled search, wherein the stalled search is continued in subsequent iterations from the different location based on the assigned parameter values;
the method further comprising, upon termination of the parallel searches, determining a set of circuit parameter values corresponding to an optimal cost function value found by the parallel searches; and
outputting the determined set of circuit parameter values.

2. A method according to claim 1, wherein the stall criterion comprises the gradient vanishing at the search space location of the given search.

3. A method according to claim 1, wherein the stall criterion is based on the norm or magnitude of the gradient vector at the search location of the given search, the method preferably comprising determining whether the stall criterion is met based on comparing a measure determined from the norm or magnitude of the gradient vector at the search location to a threshold.

4. A method according to claim 3, wherein the measure is based on an average norm or magnitude of the gradient vector at the location of the given search over a number of search iterations, preferably a predetermined window of search iterations ending at the current iteration.

5. A method according to claim 1, wherein the stall criterion comprises the search having reached a barren plateau in the cost function landscape.

6. A method according to claim 1, wherein assigning to the stalled search a new set of parameter values comprises:
selecting another one of the searches that has not stalled according to the stall criterion; and
assigning to the stalled search a set of parameter values based on the selected other search.

7. A method according to claim 6, wherein selecting another one of the searches comprises selecting the other search randomly.

8. A method according to claim 6, wherein assigning to the stalled search a new set of parameter values based on the selected other search comprises assigning a parameter value set corresponding to a location in the search space that lies on the search space path of the other search.

9. A method according to claim 6, wherein assigning to the stalled search a new set of parameter values based on the selected other search comprises assigning, to the stalled search, a current parameter value set of the other search corresponding to the most recent location in the search space of the other search.

10. A method according to claim 6, wherein the stalled search and the selected search evolve independently in subsequent iterations of the optimisation process.

11. A method according to claim 1, wherein assigning to the stalled search a new set of parameter values comprises assigning a randomly selected set of parameter values to the stalled search.

12. A method according to claim 1, wherein assigning to the stalled search a new set of parameter values comprises selecting one of a plurality of available assignment strategies and assigning the new set of parameter values using the selected assignment strategy, wherein the assignment strategy is preferably chosen randomly in accordance with respective probabilities associated with the available assignment strategies.

13. A method according to claim 12, wherein the available assignment strategies comprise assigning a set of parameter values based on another one of the searches that has not stalled, and random assignment of a set of parameter values.

14. A method according to claim 1, wherein the identifying step comprises evaluating each of the parallel searches, preferably at each optimisation iteration, to identify one or more stalled searches, and performing the step of assigning a new set of parameter values for each identified stalled search.

15. A method according to claim 1, wherein the optimisation procedure comprises a stochastic optimisation procedure.

16. A method according to claim 15, wherein the optimisation procedure comprises one of: stochastic gradient descent, SGD; simultaneous perturbation stochastic approximation, SPSA; simulated annealing; or a variation of SGD, SPSA or simulated annealing.

17. A method according to claim 1, wherein evaluating the cost function for a given set of values of the circuit parameters comprises:
running the quantum circuit on the quantum computer, including executing quantum computation operations specified by the circuit in accordance with the given set of values of the circuit parameters and measuring an output state of the quantum computer after execution of the operations; and
determining a cost function value for the given set of circuit parameter values in dependence on the measured output state;
optionally comprising determining the cost function value based on an expectation value of the output state.

18. A method according to claim 1, wherein the quantum circuit is defined by a sequence of unitary operators, each parameterized by a respective one of the circuit parameters.

19. A method according to claim 1, wherein the optimisation process is performed iteratively until a termination criterion is met, wherein the termination criterion comprises at least one of:
a predetermined number of iterations being executed;
a predetermined amount of compute time having elapsed;
the optimal cost function value found by the searches not changing between iterations or a change between iterations falling below a threshold.

20. A method according to claim 1, comprising initialising the circuit parameters for each parallel search to randomly selected values prior to a first iteration of the optimisation process.

21.-25. (canceled)
